(19) United States
(12) Patent Application Publication
(10) Pub. No.: US 2025/0042129 A1
(43) Pub. Date: Feb. 6, 2025

(54) WINDSHIELD WITH IMPROVED IMPACT PROTECTION

(71) Applicant: SAINT-GOBAIN GLASS FRANCE, COURBEVOIE (FR)

(72) Inventors: Emmanuel WALCH, HERZOGENRATH (DE); Martin LAKSHMANAN, HERZOGENRATH (DE); Malte LINN, HERZOGENRATH (DE)

(21) Appl. No.: 18/720,387

(22) PCT Filed: Dec. 6, 2022
(86) PCT No.: PCT/EP2022/084630

§ 371 Date: Jun. 14, 2024

(30) Foreign Application Priority Data
Dec. 16, 2021 (EP) 21214981.9

(51) Int. Cl. B32B 7/022; B32B 17/10

(52) U.S. Cl. CPC B32B 7/022; B32B 17/10036; B32B 17/10293; B32B 17/10761; B32B 17/10935; B32B 2307/54; B32B 2307/546; B32B 2307/7376; B32B 2605/00

(57) ABSTRACT

A windshield having a motor edge, a roof edge, and two side edges running therebetween, at least including a first pane having an outer surface and an interior-side surface and a second pane having an outer surface and an interior-side surface, wherein the interior-side surface of the first pane and the outer surface of the second pane are connected to one another via a thermoplastic intermediate layer, and wherein the first thermoplastic intermediate layer includes, at least in a first portion, a first polymer film with a first stiffness and in a second portion includes a second polymer film with a second stiffness, the second stiffness is greater than the first stiffness, the second portion is arranged along the motor edge and extends from the motor edge in the direction of the roof edge of the windshield.

The invention relates to a windshield with improved impact protection, to a method for the production thereof, and to the use thereof.

Composite panes, which comprise at least two panes and at least one polymer film adhesively bonded between the panes, have been used for decades in large quantities in various technical fields, in particular in building glazing and in vehicle construction. The selection of the materials used and the dimensioning of the components takes place as a function of the requirements of the specific intended purpose, in particular with regard to the desired mechanical load-bearing capacity of the finished glazing, taking into account the boundary conditions set by the framing and any attachments.

U.S. Pat. No. 3,437,552 A discloses composite panes comprising two glass panes and an intermediate polyvinyl butyral (PVB) layer.

U.S. Pat. No. 6,708,595 B1 discloses an armored composite glass pane for motor vehicles, which comprises a stack sequence of a plurality of panes and a plurality of adhesive intermediate layers between them.

In the automotive industry in particular, there is a trend towards the use of thinner and therefore lighter glass in laminated glass panes as part of efforts to reduce weight and thus achieve fuel and electricity savings. Nevertheless, these glazings must satisfy specific mechanical requirements which are set out in relevant industry standards. In this context, safety requirements increase not only for vehicle occupants but also for other road users, such as pedestrians. In the event of a frontal collision between a pedestrian and a car, there is a high probability that the pedestrian will hit the hood of the car, causing their head to hit the windshield of the car. This can result in serious to fatal injury to the pedestrian, in particular if their head breaks through the windshield and collides with other objects, such as the dashboard.

JP 2008 133141 A discloses a composite pane comprising an intermediate layer having a first region and a second region, wherein the first region of the intermediate layer has higher tensile stiffness than the second region.

The invention is therefore based on the object of providing an improved windshield which, on the one hand, offers greater accident safety for pedestrians and, on the other hand, ensures the relevant standards for the mechanical load-bearing capacity of windshields.

According to the proposal of the invention, this object is achieved by a windshield according to claim 1. Advantageous embodiments of the invention emerge from the dependent claims.

The windshield according to the invention comprises at least a first pane and a second pane, which are connected to one another by a thermoplastic intermediate layer. The peripheral edge of the windshield has four portions which, with respect to the installation situation of the windshield in a motor vehicle, are referred to as the motor edge, roof edge and side edges, wherein two side edges opposite one another connect the motor edge and the roof edge to one another. The first pane has an outer surface I and an interior-side surface II. The second pane has an outer surface III and an interior-side surface IV. When the windshield is installed in a motor vehicle, the outer surfaces of the panes face the vehicle environment, while the interior-side surfaces each denote the surfaces of the panes facing the vehicle interior. The interior-side surface II of the first pane is connected to the outer surface III of the second pane via the thermoplastic intermediate layer. The first thermoplastic intermediate layer has at least a first portion and a second portion, wherein the intermediate layer comprises a first polymer film with a first stiffness in the first portion and a second polymer film with a second stiffness in the second portion. The second portion is located adjacent to the motor edge of the windshield, wherein the second polymer film forms the intermediate layer along the motor edge and extends therefrom in the direction of the roof edge of the windshield. The second stiffness of the second polymer film is greater than the first stiffness of the first polymer film so that the thermoplastic intermediate layer has improved stiffness in the vicinity of the motor edge. The modulus of elasticity of the first and the second polymer film can be considered as a measure of the stiffness of the films. The value for the modulus of elasticity increases with the resistance that a material provides to counter its elastic deformation. This means that a material with a higher modulus of elasticity is stiffer than a material with a lower modulus of elasticity. The first polymer film has a modulus of elasticity of less than 20 MPa, and the second polymer film has a modulus of elasticity of greater than 100 MPa, in each case measured according to the standard ASTM D882. The thickness of the first polymer film differs by less than 10% from the thickness of the second polymer film.

Tests by the inventors have shown that the windshield has improved mechanical stability in the region of the second polymer film adjacent to the motor edge when an object strikes the windshield. Here the stiffer polymer film reduces or prevents the head from penetrating the windshield when the glass has already broken. Such a windshield also offers greater safety for a pedestrian in the event they are involved in a traffic accident, as the deformation of the windshield by the impact of the human head in a frontal collision is reduced. This prevents or reduces an impact of the head on objects behind the windshield in the vehicle interior. The second polymer film with higher stiffness has lower extensibility, i.e. the maximum elongation before the film tears is reduced compared to the first polymer film. In this respect, it is advantageous to also design a first portion with a first polymer film, going beyond the second portion. The film thicknesses of the first and second polymer film should be selected to be as similar as possible in order to avoid tension in the region where the first polymer film and the second polymer film adjoin one other when laminating the composite pane.

The windshield is provided for separating a vehicle interior from an external environment. The windshield is therefore a window pane which is inserted into a window opening in the vehicle body or is provided for this purpose. The windshield is recessed between the hood, the body roof and the A-pillars of the vehicle body in the opening provided therefor in the body. The edge of the windshield closest to the motor region of the vehicle in the installed state is referred to as the motor edge, while the edge opposite the motor edge is called the roof edge and is adjacent to the vehicle roof. The two edges of the windshield, which extend adjacently to the A-pillars, also known as A-columns, are referred to as side edges of the windshield and connect the motor edge and the roof edge to one another. The first pane represents the outer pane of the windshield, which faces the external vehicle environment, while the second pane of the windshield forms the inner pane, which is oriented toward the vehicle interior. It goes without saying that the first pane, the second pane and the thermoplastic intermediate layer have substantially the same outer dimensions. The surface of the relevant pane which faces the external surroundings of the vehicle when installed is referred to as the outer surface. The surface of the relevant pane which faces the interior of the vehicle when installed is referred to as the interior-side surface. The interior-side surface of the outer pane is connected via the thermoplastic intermediate layer to the outer surface of the inner pane. The outer surface of the outer pane is usually referred to as “side I,” the interior-side surface of the outer pane as “side II,” the outer surface of the inner pane as “side III,” and the interior-side surface of the inner pane as “side IV.”

The windshield according to the invention has a first surface region, referred to as the first portion, and a second surface region, also referred to as the second portion. There can also be a plurality of first portions and/or second portions, wherein the stiffness of the second polymer films in the second portions is in each case greater than the stiffness of the first polymer films in the first portions. The first polymer film or first polymer films and the second polymer film or second polymer films collectively form the thermoplastic intermediate layer, which connects the first pane and the second pane over their entire surface. According to the invention, the thermoplastic intermediate layer comprises at least a first polymer film having a first stiffness and a second polymer film having a second stiffness. The thermoplastic intermediate layer can comprise one or more further films. These can be for example films which have electrically switchable functions or colored regions. In a preferred embodiment, the windshield has only a first portion and a second portion, which collectively cover the total surface of the windshield.

The first polymer film and the second polymer film can each be of single-layer or multilayer construction. In one possible embodiment, the first polymer film is designed as a film laminate and/or the second polymer film is designed as a film laminate, for example as a film laminate having three layers. The first polymer film and the second polymer film are preferably designed as single-layer films.

Preferably, the second portion takes up less than 60%, preferably less than 50%, particularly preferably 10% to 40%, in particular 20% to 40%, of the total surface of the windshield. The higher the stiffness of a polymer film, the less flexible the film, which entails reduced tear resistance and reduced flowability during lamination. The second polymer film with increased stiffness thus has these disadvantages, whereas the first polymer film exhibits good tear resistance and flowability when heated. In the event that the second polymer film is introduced across the entire surface of the composite pane, impaired composite quality of the windshield is to be expected. However, if the first polymer film is used over the entire surface, the desired reduced deformation of the windshield cannot be achieved. Tests have shown that the above-mentioned preferred surface portions of the second portion are sufficient to reduce the penetration depth of the head into the windshield in traffic accidents involving pedestrians. In this case, the remainder of the first portion is sufficiently large to ensure a good connection of the panes of the windshield. Improved traffic safety can thus be achieved while maintaining the same mechanical stability of the windshield.

Preferably, the second portion extends, at least in portions, from the motor edge of the windshield in the direction of the roof edge of the windshield by an amount that corresponds to 10% to 60%, preferably 15% to 50%, particularly preferably 20% to 30% of the height of the windshield. The height of the windshield is determined here by measuring the shortest distance to the roof edge in the relevant position of the motor edge. Subsequently, the amount by which the second portion extends in the direction of the roof edge is determined at the same position of the motor edge as the shortest distance between the motor edge and the edge of the second polymer film offset in the direction of the roof edge, resulting in the height of the second polymer film at this position along the motor edge. This height of the second polymer film is set in relation to the height of the windshield, measured in each case at the same position along the windshield, thereby obtaining the relative amount by which the second portion extends from the motor edge toward the roof edge. The height up to which the second polymer film extends is determined on the basis of the vehicle geometry, wherein preferably the region where the head of a pedestrian would be highly likely to hit in the event of an accident is provided with the second polymer film. The second polymer film is attached in the vicinity of the motor edge and extends therefrom, at least in portions, as far as said height of the windshield. “In portions” means that the second polymer film, in at least one portion along the motor edge of the windshield, protrudes into the windshield up to the aforementioned height in the direction of the surface center, but can also have a lower height in other portions. The upper edge of the second polymer film, i.e. the edge of the second polymer film with the greatest distance from the motor edge of the windshield, preferably runs in a straight line or a curve between the side edges of the windshield.

In a particularly preferred embodiment, the size of the second portion is selected such that, when the windshield is installed in a motor vehicle, the size of the second portion corresponds to at least 70%, preferably at least 90%, of the surface area of the region of the dashboard of the motor vehicle that projects onto the windshield. Particularly preferably, the size of the second portion corresponds to at least the surface area of the region of the dashboard that projects onto the windshield. A common accident scenario involving pedestrians is that the pedestrian's head hits the windshield in the region of the dashboard. If the windshield is broken through in this region, the head of the pedestrian directly strikes the dashboard therebehind, increasing the likelihood of serious injury. In this respect, it is advantageous to design the region of the windshield that is covered by a region the dashboard that projects onto the windshield in the installed state as a second portion with a second polymer film, which reduces the penetration depth of the head into the windshield after the pane breaks. This is particularly advantageous if other elements are located behind the windshield, such as the dashboard or an HUD projector. Due to the smaller penetration depth of the head, the risk of a second impact on an element located behind the windshield is considerably reduced. The element behind the windshield, for example the dashboard, is substantially stiffer compared to the broken glass. As a result, such a second impact causes the pedestrian's head to decelerate sharply, which often causes serious injuries. It is therefore desirable to avoid the second impact or to sufficiently reduce the kinetic energy of the head before the second impact. This is possible with the windshield according to the invention.

The thickness of the first polymer film preferably differs by less than 5% from the thickness of the second polymer film. The thicknesses of the first type of polymer film and of the second type of polymer film are substantially the same. This prevents stresses in the laminated glass pane due to variations in thickness at the transition between the first and second portion.

The first polymer film and the second polymer film each comprise one or more individual layers. The thickness of the first polymer film and of the second polymer film is preferably between 300 μm and 1000 μm, particularly preferably between 500 μm and 900 μm, in particular between 650 μm and 850 μm in each case. Furthermore, it is preferably provided that the thickness of the first and second polymer film is the same. In principle, thicker or thinner polymer films can also be used, and even slight differences in thickness between the polymer film of the first type and the polymer film of the second type may be acceptable; however, the above-mentioned thickness range and corresponding thicknesses of the two films are technologically advantageous.

The first polymer film and/or the second polymer film preferably comprise polyvinyl butyral (PVB), polyurethane (PU), ionomers and/or ethylene vinyl acetate (EVA). These materials have proven to be particularly suitable for securely connecting the panes to one other.

In a preferred embodiment, the first polymer film is a PVB film with a modulus of elasticity of less than 20 MPa, while the second polymer film is a PVB film with a modulus of elasticity of greater than 100 MPa, each measured according to the standard ASTM D882.

In a further preferred embodiment, it is provided that the first type of polymer film is a PVB film having a modulus of elasticity of less than 20 MPa and the second type of polymer film is an ionomer film having a modulus of elasticity of greater than 300 MPa, each measured according to standard ASTM D882.

In principle, however, polymer films with a different chemical composition can be used both for the first surface region and for the second portion provided they meet the other requirements regarding transparency and durability and the above-mentioned relationship between the stiffnesses or moduli of elasticity of the first and second polymer films is maintained.

In principle, with regard to the greatest possible load-bearing capacity of the windshield, it is desirable to provide larger surface portions with the second polymer film, but this is generally not desirable due to the lower tear resistance of the second polymer film, and for cost reasons. The second portion with the second polymer film preferably has a surface portion of less than 60%, particularly preferably less than 50%, in particular less than 40% of the total surface of the windshield. This is sufficient to cover the pane region adjacent to the motor edge and, furthermore, to minimize the proportion of the second portion, which is advantageous with regard to improved tear resistance of the first polymer film.

The first polymer film has a first peripheral film edge and the second polymer film has a second peripheral film edge. The first polymer film and the second polymer film adjoin one another at the transition between the first portion and the second portion. There, there is direct contact between a portion of the first peripheral film edge and a portion of the second peripheral film edge, wherein the two film edges which are in direct contact form a common contact edge. The contact edge preferably extends between the side edges of the windshield, wherein the contact line can end at the side edges of the windshield, but does not have to. This means that the contact edge can meet the relevant side edge at one or both side edges of the windshield.

The second portion, in which the second pane is connected to the third pane via the second polymer film, can in principle have any shape and preferably has the shape of a rectangle or a rounded rectangle or a semicircle or a half ellipse, in each case adjacently to the motor edge of the windshield. Depending on the geometry of the windshield, other shapes are also possible.

In a preferred embodiment, the contact edge runs in a straight line between the side edges and ends at the side edges of the windshield. For a straight contact edge, a course that is horizontal when the windshield is installed in the vehicle has proven to be advantageous in order to uniformly achieve the improved safety properties associated with the second polymer film in all regions along the motor edge.

In a further preferred embodiment, the contact edge has a curved shape, wherein material of the second polymer film can be saved in the regions of the windshield where a person is unlikely to make impact, while the height of the second portion can be selected to be greater in regions with a high probability of impact.

The first pane and the second pane are preferably made of glass, particularly preferably of soda-lime glass, as is customary for window panes. However, the panes can also be manufactured from other types of glass, for example quartz glass, borosilicate glass or aluminosilicate glass, or from rigid clear plastics, for example polycarbonate or polymethyl methacrylate.

The first pane and the second pane and the third pane can be made, independently of one another, of non-prestressed, partially prestressed or prestressed glass. If the first pane and/or the second pane are intended to be prestressed, this can be thermal or chemical prestress.

The first and the second pane preferably each have a thickness of 0.8 mm to 2.5 mm, particularly preferably of 1.2 mm to 2.2 mm. The thickness of the first pane is typically from 1.0 mm to 2.5 mm. The thickness of the second pane is preferably between 0.8 mm and 2.1 mm. The thickness of the first pane is preferably greater than the thickness of the second pane. For example, the first pane can be 2.1 mm thick and the second pane 1.1 mm thick, or the first pane can be 1.8 mm thick and the second pane 1.4 mm thick, or the first pane can be 1.6 mm thick and the second pane 1.1 mm thick, or the first pane can be 1.6 mm thick and the second pane 0.7 mm thick, or the first pane can be 1.4 mm thick and the second pane 1.1 mm thick.

The first pane, the second pane and the thermoplastic intermediate layer can be clear and colorless, but also tinted or colored. Tinting of the outer pane, inner pane and of the thermoplastic intermediate layer is selected on the basis of the desired use of the composite pane. For windshields, high transmission in the visible range of the light spectrum is desired and dark tinting of the components is not provided. In one embodiment as a windshield for a motor vehicle, the total transmission through the windshield is greater than 70% based on light type A. The term “total transmission” relates to the method defined by ECE-R 43, Annex 3, Section 9.1 for testing the light transmission of automotive glass.

The vehicle composite pane according to the invention is preferably curved in one or more spatial directions, as is usual for motor vehicle panes, the typical radii of curvature being in the range of from approximately 10 cm to approximately 40 m. However, the laminated pane can also be flat, for example if it is provided as a pane for buses, trains or tractors.

The first pane, the second pane and/or the thermoplastic intermediate layer can have further, suitable coatings known per se, e.g., anti-reflective coatings, non-stick coatings, anti-scratch coatings, photocatalytic coatings or sun protection coatings, or low-e coatings.

Automotive glazings, in particular windshields, rear windows, and roof panes, usually have a peripheral cover imprintment made of an opaque enamel, which in particular serves to protect from UV radiation and optically cover the adhesive used for installing the pane. Preferably, at least the first pane used as an outer pane has such a cover imprintment, particularly preferably both the first pane and the second pane (inner pane and outer pane) are printed on so that a through-view from either side is prevented. The opaque cover imprintment is for example applied in the form of a screen print so that this screen print circumscribes the field of view of the pane or forms its outer edge. Electrical conductors which may be arranged in the edge region of the pane, and in the case of coated panes, an optionally provided coating-free edge region, are preferably covered by this cover imprintment and are therefore visually concealed. The opaque screen print can be applied in any plane of the laminated glass pane.

The invention further comprises a method for producing a windshield according to the invention which comprises the following method steps:
a) providing a first pane and a second pane,
b) placing a thermoplastic intermediate layer comprising a first polymer film and a second polymer film onto the first pane or the second pane,
c) finishing the layer stack with the second pane or first pane,
d) laminating the layer stack consisting of at least the first pane, thermoplastic intermediate layer and second pane to form the windshield.

The thermoplastic intermediate layer can be placed in position in step b) by positioning the first polymer film and the second polymer film either simultaneously or one after the other. The first polymer film and the second polymer film are cut to size before or after the placement of the first polymer film and the second polymer film in step b), but in any case before step c). The first polymer film and/or the second polymer film can also be realized in the form of a plurality of films, for example two or more thermoplastic films.

If coatings, such as sun protection coatings or heatable coatings, are to be applied to the surfaces of the first pane and the second pane facing the thermoplastic intermediate layer, the panes are preferably joined to form the laminated glass after the coating has been applied. If the windshield comprises coatings which are to be contacted electrically, the electrical contacting of the electrically conductive layers takes place via busbars or other suitable electrical conductors before the lamination of the composite pane.

Any prints that may be provided, for example opaque cover imprintments, are preferably applied using a screen-printing process.

The first pane and second pane are connected via the thermoplastic intermediate layer to form the windshield, preferably by lamination under the action of heat, a vacuum and/or pressure. Methods known per se for producing a laminated glass pane can be used. During lamination, the heated, flowable thermoplastic material flows to create a stable composite.

For example, so-called autoclave methods can be carried out at an elevated pressure of approximately 10 bar to 15 bar and at temperatures of 130° C. to 145° C. for approximately 2 hours. Vacuum bag or vacuum ring methods known per se operate, for example, at approx. 200 mbar and 80° C. to 110° C. The first pane, the thermoplastic intermediate layer, and the second pane can also be pressed in a calender between at least one pair of rollers to form one pane. Systems of this type are known for producing panes and normally have at least one heating tunnel upstream of a pressing unit. The temperature during pressing is, for example, from 40° C. to 150° C. Combinations of calender and autoclave methods have proven particularly successful in practice. Vacuum laminators can be used as an alternative. These consist of one or more heatable and evacuable chambers, in which the panes are laminated within, for example, approximately 60 minutes at reduced pressures of 0.01 mbar to 800 mbar and temperatures from 80° C. to 170° C.

The invention further comprises the use of the windshield according to the invention in motor vehicles, particularly preferably in a passenger car. The invention can also be used in contiguous panoramic glazings in which the windshield comprises a portion of the roof.

All the standards mentioned relate to their version valid as on the filing date of the invention.

The various embodiments of the invention may be implemented individually or in any combinations. In particular, the features mentioned above and yet to be explained below can be used not only in the specified combinations but also in other combinations or alone without departing from the scope of the present invention. That is the case unless exemplary embodiments and/or their features are explicitly mentioned only as alternatives or are mutually exclusive.

The invention will be illustrated in more detail below with reference to the drawings. It should be noted that different aspects are described, each of which can be used individually or in combination. In other words, any aspect may be used with different embodiments of the invention unless explicitly presented as a pure alternative.

The drawings are purely schematic representations and are not true to scale. The drawings do not limit the invention in any way.

### IN THE FIGURES

FIG. 1 shows a plan view of an embodiment of a windshield according to the invention,

FIG. 2 shows a detail of a cross section through the embodiment of a windshield according to the invention shown in FIG. 1, and

FIG. 3 shows a plan view of a further embodiment of a windshield according to the invention,

FIG. 4 shows a plan view of a further embodiment of a windshield according to the invention,

FIG. 5 shows a diagram with deformation curves of a sample P1 laminated with a second polymer film 3.2 in comparison with a deformation curve of a comparative sample VP laminated with a first polymer film 3.1 in the Head Penetration Test.

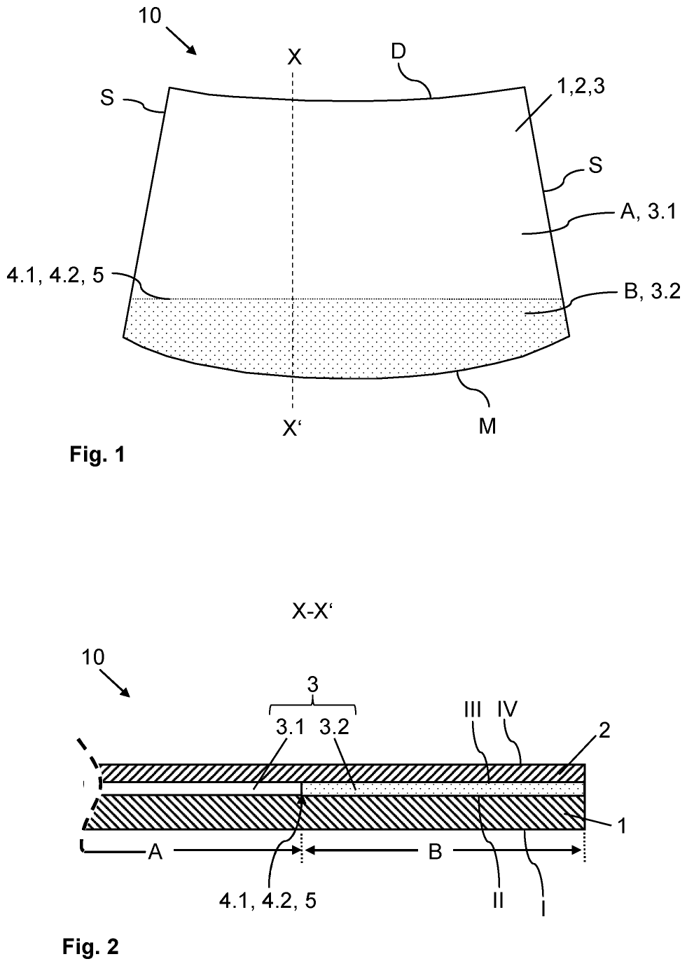

FIG. 1 shows the plan view of an embodiment of a windshield 10 according to the invention, while FIG. 2 shows a detail of a cross section through the embodiment shown in FIG. 1 along the section line X′-X according to FIG. 1.

The windshield 10 shown in FIGS. 1 and 2 comprises a first pane 1 and a second pane 2, which are connected to one another via a thermoplastic intermediate layer 3. The first pane 1 has an outer surface I and an interior-side surface II. The second pane has an outer surface Ill and an interior-side surface IV. When the windshield is installed, the outer surfaces I, III are oriented in the direction of the surroundings, while the interior-side surfaces II, IV are oriented toward the vehicle interior in the installed state. The interior-side surface II of the first pane 1 is connected via the thermoplastic intermediate layer 3 to the outer surface III of the second pane 2. The thermoplastic intermediate layer 3 comprises a first polymer film 3.1 and a second polymer film 3.2. The windshield 10 has a roof edge D, a motor edge M opposite the roof edge, and two side edges S opposite one another, which connect the motor edge M and the roof edge D to one another.

As can be seen from FIGS. 1 and 2, the second polymer film 3.2 is arranged only in a second portion B of the windshield 10 which is in the vicinity of the motor edge M. The remaining surface region of the windshield 10 shall be referred to as the first portion A. In the first portion A of the windshield 10, the thermoplastic intermediate layer 3 is formed by the first polymer film 3.1.

The first pane 1 is for example a glass pane made of soda-lime glass with a thickness of 2.1 mm. The second pane 3 is for example made of soda-lime glass and has a thickness of 1.6 mm. The first polymer film 3.1 is made for example of a PVB used as standard for such purposes and is 0.76 mm thick. The second polymer film 3.2 is for example a 0.76 mm-thick ionomer film with higher stiffness, such as is commercially available under the trade name SentryGlas®. The first polymer film 3.1 is a PVB film with a modulus of elasticity of less than 20 MPa, and the second polymer film 3.2 is an ionomer film with a modulus of elasticity of greater than 300 MPa, each measured according to the standard ASTM D882. However, a stiffer PVB film can also be used as the second polymer film, for example, which is commercially available under the name Saflex®, DG41. The first polymer film 3.1 is a PVB film with a modulus of elasticity of less than 20 MPa, while the second polymer film 3.2 is a PVB film with a modulus of elasticity of greater than 100 MPa, each measured according to the standard ASTM D882. Polymer films commercially available under the trade names Trosifol® or Evalam® can also be used as the second polymer film. The first polymer film 3.1 and the second polymer film 3.2 preferably have the same thickness. The first polymer film 3.1 has a first peripheral film edge 4.1, while the second polymer film 3.2 has a second peripheral film edge 4.2. The first peripheral film edge 4.1 and the second peripheral film edge 4.2 are in direct contact with one another in a portion, wherein this portion is referred to as the contact edge 5. The contact edge 5 of the two polymer films 3.1, 3.2 runs in a straight line between the side edges K.

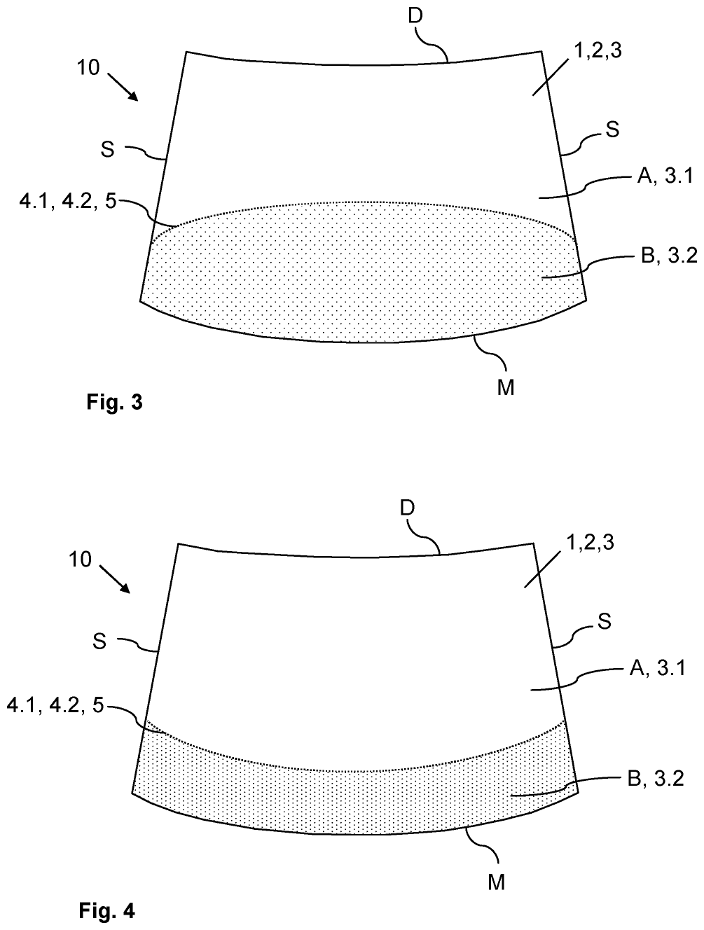

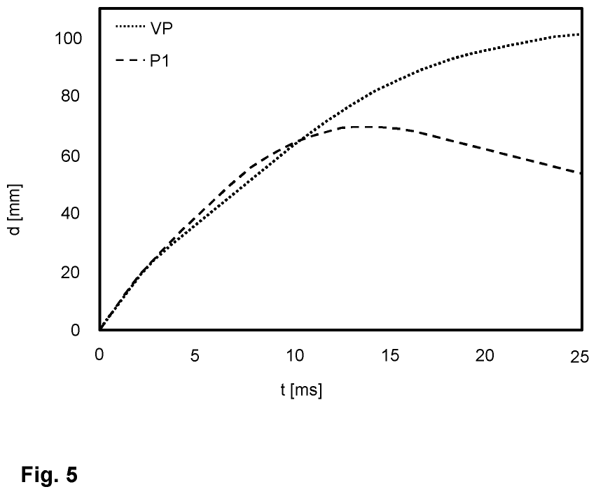

FIGS. 3 and 4 show further embodiments of a windshield 10 according to the invention. The embodiments of FIGS. 3 and 4 substantially correspond to the embodiment of FIG. 1, wherein the embodiments differ in the shape of the contact edge 5. In each of FIGS. 3 and 4, the contact edge 5 is realized as a curved edge. This can save material for the second polymer film 3.2. In the embodiment in FIG. 3, the contact edge 5 runs in a curve in the direction of the side edges 5 and ends at said side edges. According to the embodiment of FIG. 4, the contact edge 5 extends in the direction of the side edges K and runs approximately in parallel with the motor edge M.

The effect of increasing the mechanical load-bearing capacity against deformation in the region of a second polymer film 3.2 could also be confirmed by the inventors using experiments. For this purpose, the inventors carried out tests with samples laminated with a second polymer film 3.2 between a first pane 1 made of glass and a second pane 2 made of glass. In this case, the second polymer film 3.2 was a PVB film with a thickness of 0.76 mm and a modulus of elasticity of greater than 100 MPa, measured according to standard ASTM D882. A comparative sample was prepared using the same panes 1, 2, but laminated using a first polymer film 3.1 with a thickness of 0.76 mm and a modulus of elasticity of less than 20 MPa, measured according to standard ASTM D882. Both samples had a size of 1100 mm×500 mm, wherein the a first pane 1 had in each case a thickness of 2.1 mm and the second pane 2 had in each case a thickness of 1.6 mm. A Head Penetration Test was carried out on both samples in accordance with the ECE-R127 standard, wherein a measuring head weighing 4.5 kg is dropped at a speed of 35 km/h onto the sample with the second polymer film 3.2 and onto the comparative sample with the first polymer film 3.1. The maximum degree of deformation of the sample caused by the impact of the measuring head is then determined. FIG. 5 shows a comparison of the deformation curves for the sample P1 with the second polymer film 3.2 and the comparative sample VP with the first polymer film 3.1. The deformation d in mm is measured here as a function of time t in ms after the impact at the time t=0. The comparative sample VP had a maximum degree of deformation of 101 mm, while the sample P1 with the second polymer film 3.2 reached a maximum degree of deformation of 69 mm. The second polymer film 3.2 can therefore reduce the maximum degree of deformation on impact in the Head Penetration Test by approximately 32%. Such an improvement is also to be expected if a pedestrian hits in the second portion B with the second polymer film 3.2.

### LIST OF REFERENCE SIGNS

10 windshield
1 first pane
2 second pane
3 thermoplastic intermediate layer
3.1 first polymer film
3.2 second polymer film
4.1 first peripheral edge
4.2 second peripheral edge
5 contact edge
A first portion
B second portion
D roof edge
M motor edge
S side edges
I outer surface of the first pane 1
II interior-side surface of the first pane 1
III outer surface of the second pane 2
IV interior-side surface of the second pane 2

1. A windshield having a motor edge, a roof edge, and two side edges running therebetween, at least comprising a first pane having an outer surface and an interior-side surface and a second pane having an outer surface and an interior-side surface, wherein the interior-side surface of the first pane and the outer surface of the second pane are connected to one another via a thermoplastic intermediate layer, and wherein
the first thermoplastic intermediate layer comprises, at least in a first portion, a first polymer film with a first stiffness and in a second portion comprises a second polymer film with a second stiffness,
the second stiffness is greater than the first stiffness,
the second portion is arranged along the motor edge and extends from the motor edge in a direction of the roof edge of the windshield,
the first polymer film has a modulus of elasticity of less than 20 MPa, and the second polymer film has a modulus of elasticity of greater than 100 MPa, in each case measured according to standard ASTM D882, and
a thickness of the first polymer film differs by less than 10% from a thickness of the second polymer film.

2. The windshield according to claim 1, wherein the second portion takes up less than 60% of a total surface area of the windshield.

3. The windshield according to claim 1, wherein the second portion extends, at least in portions, from the motor edge of the windshield in the direction of the roof edge of the windshield by an amount that corresponds to 10% to 60% of a height of the windshield.

4. The windshield according to claim 1, wherein a size of the second portion is selected such that, when the windshield is installed in a motor vehicle, the size of the second portion corresponds to at least 70% of a surface area of a region of a dashboard of the motor vehicle that projects onto the windshield.

5. The windshield according to claim 1, wherein the thickness of the first polymer film differs by less than 5% from the thickness of the second polymer film.

6. The windshield according to claim 1, wherein the first polymer film and the second polymer film each comprise one or more individual layers, and the thickness of the first polymer film and of the second polymer film is in each case between 300 μm and 1000 μm.

7. The windshield according to claim 1, wherein the first polymer film and/or the second polymer film comprise polyvinyl butyral (PVB), polyurethane (PU), ionomers and/or ethylene vinyl acetate (EVA).

8. The windshield according to claim 1, wherein the first polymer film is a PVB film with a modulus of elasticity of less than 20 MPa and the second polymer film is a PVB film, a PU film, an ionomer film or an EVA film with a modulus of elasticity of greater than 100 MPa, in each case measured according to standard ASTM D882.

9. The windshield according to claim 1, wherein the second portion with the second polymer film has a surface portion of less than 60% of a total surface of the windshield.

10. The windshield according to claim 1, wherein the first polymer film has a first peripheral film edge and the second polymer film has a second peripheral film edge, and the first peripheral film edge is in direct contact with the second peripheral film edge, at least in portions, and the first peripheral and second peripheral film edges in direct contact form a common contact edge.

11. The windshield according to claim 10, wherein a contact line between the first peripheral and second peripheral film edges runs between the two side edges.

12. The windshield according to claim 1, wherein the first pane and the second pane comprise glass and each have a thickness of 0.8 mm to 2.5 mm.

13. A method for producing a windshield according to claim 1, comprising:
a) providing a first pane or a second pane,
b) positioning a thermoplastic intermediate layer comprising a first polymer film and a second polymer film on the first pane or the second pane,
c) forming a layer stack with the second pane or the first pane, and
d) laminating the layer stack consisting of at least the first pane, the thermoplastic intermediate layer and the second pane to form a windshield.

14. The method according to claim 13, wherein the first polymer film and the second polymer film are positioned either simultaneously or one after the other in step b).

15. Use of A method comprising providing a windshield according to claim 1 in a motor vehicle.

16. The windshield according to claim 2, wherein the second portion takes up less than 50% of the total surface area of the windshield.

17. The windshield according to claim 3, wherein the second portion extends, at least in portions, from the motor edge of the windshield in the direction of the roof edge of the windshield by an amount that corresponds to 15% to 50% of the height of the windshield.

18. The windshield according to claim 4, wherein the size of the second portion is selected such that, when the windshield is installed in a motor vehicle, the size of the second portion corresponds to at least 90% of the surface area of the region of the dashboard of the motor vehicle that projects onto the windshield.

19. The windshield according to claim 6, wherein the thickness of the first polymer film and of the second polymer film is in each case between 500 μm and 900 μm.

20. The windshield according to claim 8, wherein the second polymer film is a PVB film with a modulus of elasticity of greater than 100 MPa or an ionomer film with a modulus of elasticity of greater than 300 MPa, in each case measured according to standard ASTM D882.
